(19) United States
(12) Patent Application Publication
(10) Pub. No.: US 2009/0223696 A1
(43) Pub. Date: Sep. 10, 2009

(54) Exterior semi-recessed electric junction box

(76) Inventor: Douglas S. Gawoski, San Rafael, CA (US)

Correspondence Address: Douglas S. Gawoski, 10 Nevada Street, San Rafael, CA, 94901, US

(21) Appl. No.: 12/074,897

(22) Filed: Mar. 7, 2008

(51) Int. Cl. H01H 9/02

(52) U.S. Cl. 174/58

(57) ABSTRACT

The exterior semi-recessed electrical junction box is used in conjunction with other building materials in the exterior walls of buildings to protect the building structure from water intrusion. A projecting flange integral to the junction box is sequenced with surrounding waterproofing materials to protect the opening made in wall sheathing for the junction box from water intrusion. A collar extending from the flange of the exterior semi-recessed electrical junction box accommodates various electrical devices and wall finish thickness, terminating with a flange for mounting and sealing a weatherproof junction box cover or electrical device.

### CROSS REFERENCE TO RELATED APPLICATIONS AND DISCLOSURES

This non-provisional utility patent application claims the benefit of provisional patent application Ser. No. 60/905,499 filed Mar. 8, 2007.

### BACKGROUND OF THE INVENTION

Electrical junction boxes are used to make accessible splices and connections in electrical conductors or wiring used in building construction. Electrical devices are also fastened to or installed in junction boxes, with electrical connections to devices made within the junction box. When electrical devices are installed at outside walls, weather resistant exterior junction boxes and covers with gaskets are currently available that are surface mounted outside of the building wall. These surface mounted electric junction boxes are commonly for use with surface mounted electrical conduit, but are also used in concealed sheathed wiring applications because of the weather resistant rating of the box and its cover. Although this surface location satisfies electrical connection and weather exposure concerns, many types of exterior lights and other electric devices cannot be mounted to surface mounted electric junction boxes.

Where exterior electric light fixtures, or flush mounted electrical receptacles are needed at exterior building walls, an interior type electrical junction box is installed to wall framing, with the box accessible to the exterior for wire connections through a hole cut through exterior wall sheathing and the wall moisture barrier. The interior junction box used in these cases is not intended for exterior use, but standardized electric device mounting holes allow the use of weather resistant covers and gaskets used with surface mounted exterior junction boxes. Additional retrofit products or measures can be used to restore the weather resistance of the exterior wall where the wall moisture barrier has been cut. Where weather resistance is not restored through use or proper placement of retrofit products or materials, the hole in the wall can allow moisture to enter the wall cavity. Framing and other building components are degraded from water exposure, and trapped moisture can support detrimental mold and mildew growth.

Where gaskets or seals of weatherproof junction box covers are inadequate or fail, moisture entering a junction box can bypass wall moisture barriers and flow into a wall cavity through conductor access holes in some junction boxes.

The Exterior Semi Recessed Electrical Junction Box addresses weather resistance of the exterior wall during installation by means of an integral and continuous perimeter flange which can be integrated into the primary moisture barrier of exterior wall construction, a collar extending from the flange, and a cover mounting flange. The exterior semi-recessed electrical junction box addresses moisture that bypasses weatherproof covers and enters the junction box through sloping box surfaces and moisture weep holes located outside of the perimeter flange. Other elements of the Exterior Semi Recessed Electrical Junction Box allow access for one or more electrical conductors or wires, lugs with holes for mounting and fastening of electrical devices, and mounting holes in the perimeter flange for installation against a wall surface.

### SUMMARY OF THE INVENTION

The exterior semi-recessed electrical junction box is a one-piece item manufactured from plastic, used like other electric junction boxes in building electrical wiring where an electrical wiring connection is made or where an electrical device is installed. The subject of the invention has openings to accept and retain common sizes of sheathed electrical wiring and interior dimensions and pre-formed holes to accommodate common electric devices and fixtures like all junction boxes. The exterior semi-recessed electrical junction box differs from currently available junction boxes by means of a integral and continuous flange sequenced with building moisture barriers to protect the joint between the electrical box and building moisture barrier from water intrusion, a collar which accommodates various siding types and a cover mounting flange which aligns and forms a seal with common exterior junction box covers and gaskets.

The perimeter flange of the exterior semi-recessed electrical junction box is sequenced with other construction materials during the construction of exterior walls of building, before the exterior wall finish is installed. If moisture gains entry through construction joints between the installed exterior semi-recessed electrical junction box and adjacent trim or siding material of the finished building, the integral and continuous flange of the subject invention directs water to the outside of the building moisture barrier, protecting building framing and interior from moisture. The flange also provides a method of attaching the junction box to the exterior building wall.

The exterior semi-recessed electrical junction box has a collar projecting at right angles from the weatherproofing flange, to accommodate the thickness of common building siding materials, and thickened areas with holes to accept mounting screws for typical electrical devices. The collar has two weep holes oriented to the bottom in the installed position, which can allow any moisture that bypasses an installed cover and gasket to weep onto the surface of the perimeter flange and wall moisture barrier.

The collar terminates at a flange at right angles to the collar, which provides a surface for typical exterior junction box covers and gaskets to mate against in proximity of exterior wall finishes. At siding of thickness less than collar depth, the projection of the flange past the collar diverts any rainwater that runs down finished siding away from the cover joint. At cement plaster building finish siding of thickness equal to the collar depth, the flange provides a screed or reference edge assisting in the placement of the cement plaster.

### BRIEF DESCRIPTION OF THE DRAWINGS

The present invention can be utilized in many ways. The following descriptions and graphic indications represent potential uses of the invention to characterize the idea and general usefulness, and are not intended to limit the invention to that described or depicted herein. Notation numbers used within the figures correspond to the same features or components throughout the drawings. Refer to the views of the exterior semi-recessed electrical junction box contained on sheets 1 through 6:

FIG. 1 is a front view

FIG. 2 is a left side view

FIG. 3 is a top view

FIG. 4 is a bottom view

FIG. 5 is a back view

FIG. 6 is a section

FIG. 7 is a section

FIG. 8 is a section of an installed exterior semi-recessed electrical junction box.

FIG. 9 is a section of an installed exterior semi-recessed electrical junction box.

### LIST OF NOTATION USED IN THE SOME OR ALL OF THE FIGURES

1. Box portion of the one piece exterior semi-recessed electrical junction box
2. Perimeter flange
3. Collar
4. Cover mating flange
5. Electric device mounting surface lug with holes for screws
6. Preformed holes in perimeter flange for exterior wall fasteners
7. Openings for electric conductors or wire
8. Flaps at conductor or wire openings
9. Electric conductor or wire diverter
10. Ridges at electric conductor or wire openings
11. Collar weep holes
12. Electric device
13. Compressible cover gasket
14. Junction box cover
15. Stud wall framing
16. Exterior wall sheathing
17. Wall moisture barrier
18. Additional building paper
19. Exterior wall finish
20. Interior wall finish
21. Sealant over backer rod
22. Electric conductors or wiring
23. Paper backed wire lath

### DETAILED DESCRIPTION OF THE INVENTION

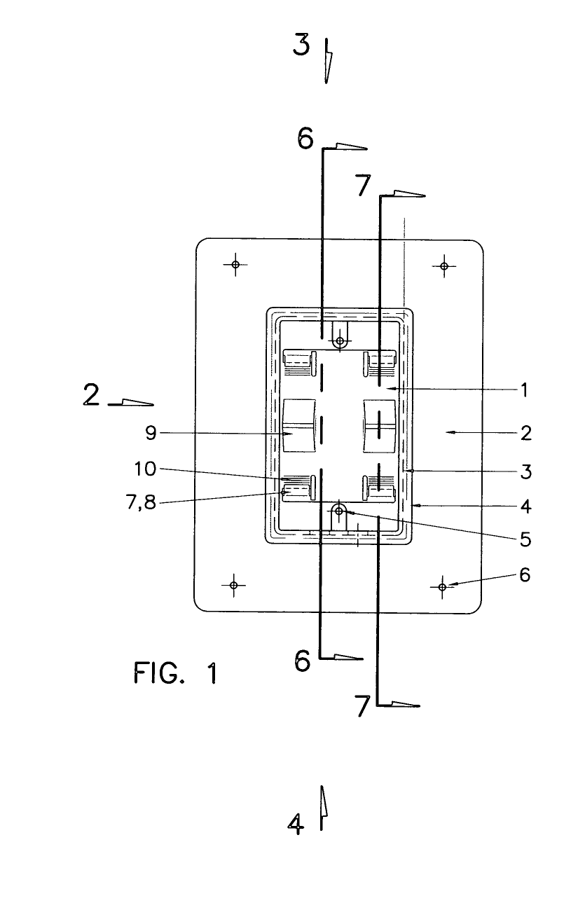

FIGS. 1-9 illustrate one embodiment of the present invention in a rectangular configuration. The illustrated embodiment does not preclude round, or other shape and size configurations of the invention to accommodate multi-gang or different electrical devices. Those skilled in the art will recognize modifications can be made to the embodiment described and shown, without departing from the scope and intention of the invention claimed.

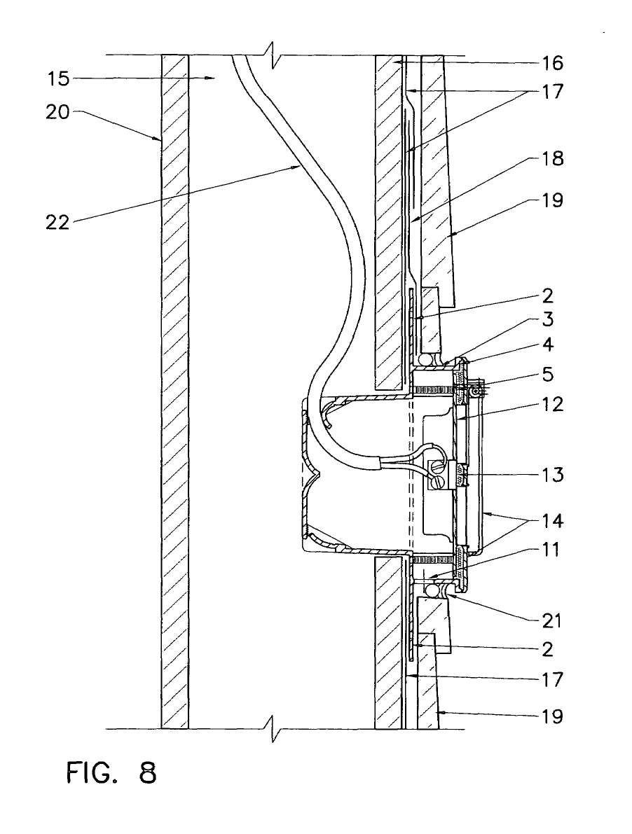

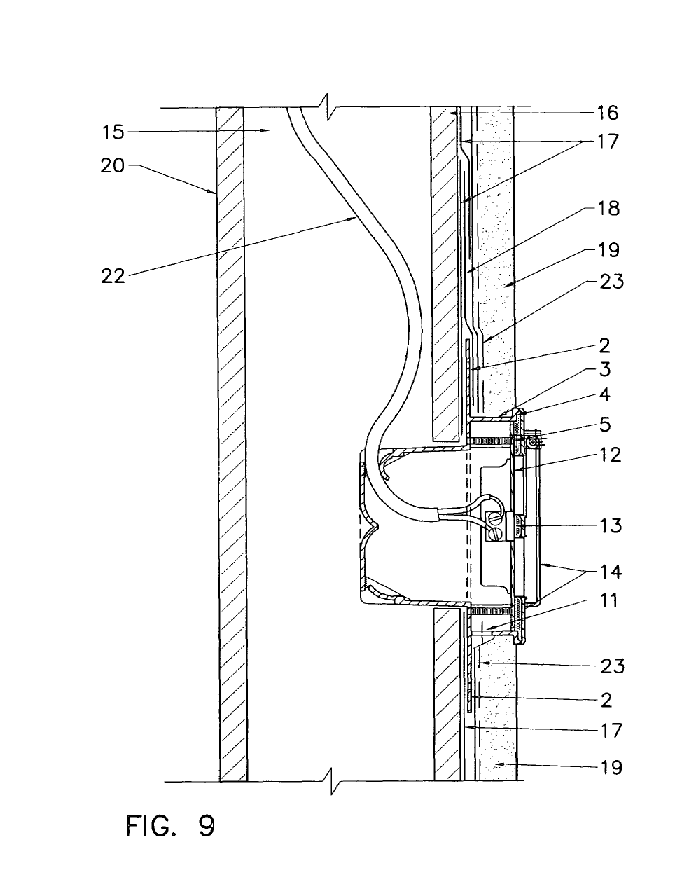

FIGS. 8 and 9 show the exterior semi-recessed electrical junction box integrated into different building components. Building components illustrated in FIGS. 8 and 9 characterize the use and installation of the present invention, but do not preclude use of the claimed invention with other electrical devices and types of weatherproof covers, or different building materials and construction components.

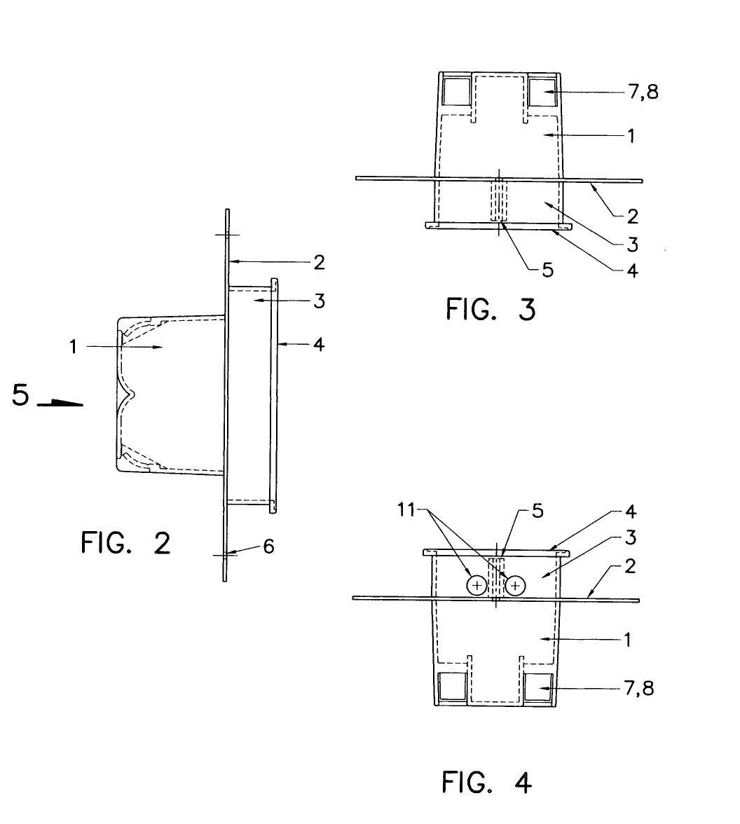

FIG. 1 is a front view of the exterior semi-recessed electrical junction box. The location and direction for FIGS. 2 through 7 are indicated on this view. As shown, the rear of the box portion 1 is smaller than the collar 3 projecting from the continuous perimeter flange 2. At the back of box portion 1, electric conductor or wire diverters 9 are located between wire access holes and opening flaps 7 and 8. Electrical device mounting surface lug 5 is within and slightly below the cover-mating flange 4.

FIG. 2 is a left side view of the exterior semi-recessed electrical junction box. The right side view not shown is a mirror image of this view. Box portion 1 slopes slightly from the back towards the front at the top, sides and bottom. The perimeter flange 2 projects perpendicular from the top and sides of the box portion 1. The collar 3 projects from the perimeter flange, terminating at cover mating flange 4. Mounting holes 6 are preformed in the perimeter flange 2.

FIG. 3 is a top view of the exterior semi-recessed electrical junction box. The box portion 1 slopes slightly from the back towards the front at the top, sides and bottom. Electrical wiring access holes 7 in box portion 1 are covered with bendable flaps 8. Electrical device mounting lug surface 5 shown as a hidden line behind collar 2, is lower than cover mating surface 4.

FIG. 4 is a bottom view of the exterior semi-recessed electrical junction box. The box portion 1 slopes slightly from the back towards the front at the top, sides and bottom. Electrical wiring access holes 7 in box portion 1 are covered with bendable flaps 8. Collar 3 has two weep holes 11 to either side of electrical device mounting lug 5.

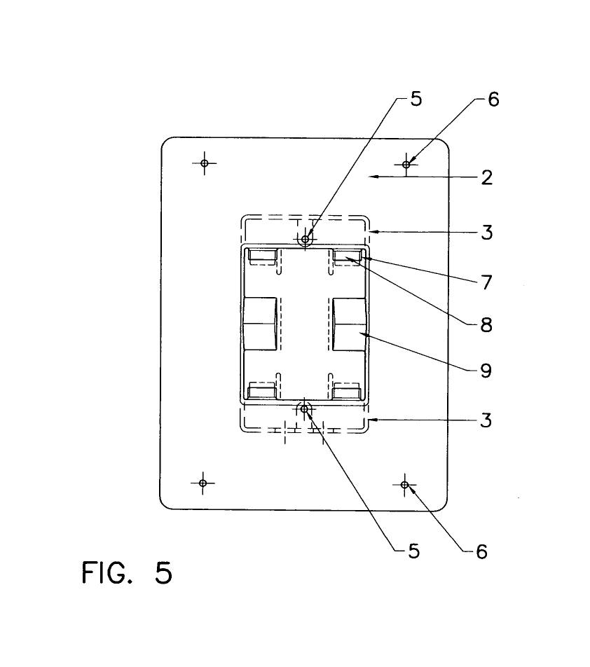

FIG. 5 is a back view of the exterior semi-recessed electrical junction box. The inside and outside corners of box portion 1 are visible because of the slight slope of the top and sides from back towards the perimeter flange 2. Electrical wiring access holes 7 in box portion 1 are covered with bendable flaps 8. The concave surface of conductor or electrical wire diverters 9 are visible between electrical wiring access holes 7. Holes 5 for mounting electric devices continue through lugs and perimeter flange 2.

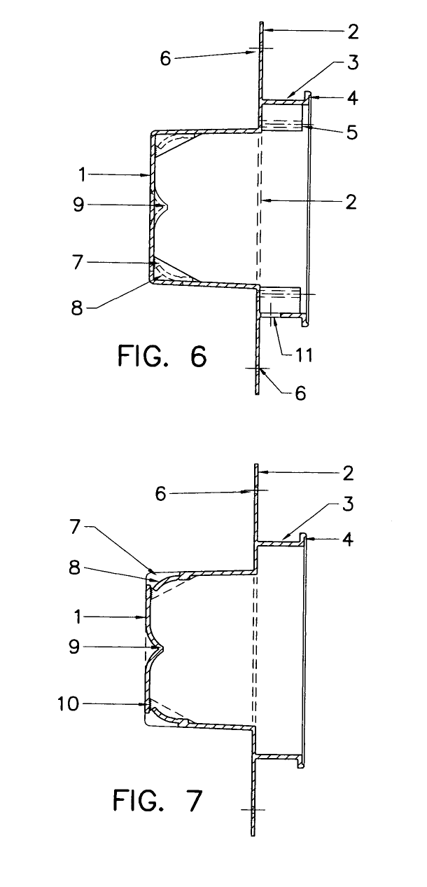

FIG. 6 is a section taken vertically through the exterior semi-recessed electrical junction box at the weep holes 11 in collar 3. Box portion 1 slopes from back to front, with collar 3 lower than box portion 1. Electrical conductor access holes 7 have an adjacent angled sidewall bridging from the back to the tops and bottoms of box portion 1. Cover mating flange 4 has a continuous raised bead at its perimeter. The surface of electric device mounting lugs 5 are lower than cover mating flange 4, and contained within collar 3.

FIG. 7 is a section taken vertically through the exterior semi-recessed electrical junction box adjacent to the sidewall of box portion 1, and through electric conductor or wire access holes 7, opening flaps 8, and wire diverters 9. Adjacent to wire access holes 7 and opening flaps 8, box portion 1 is formed with ridges 10. Rectangular shaped opening flap 8 rests against the back portion of box 1 on these ridges, attached to box portion 1 along one thickened edge, scored and free to bend/flex to allow electrical conductors or wires to enter at wire openings 7. When flexible electrical conductors or wires commonly known as ROMEX are forced through wire openings 7 from the outside of the box 1, wires are lifted upward and diverted towards the center of the box by wire diverters 9, to facilitate connection to electrical devices. Opening flaps 8 flex to allow wire conductor entry, while pinching and exerting pressure against electrical conductors or wiring.

FIG. 8 is a section of an exterior semi-recessed electrical junction box with electrical device 12; cover gasket 13; and weatherproof cover 14 installed in a stud framed 15 wall. Flexible ROMEX electrical wiring 22 is shown entering the exterior semi-recessed electrical junction box and connecting to electrical device 12. Interior wall finish 20 is shown for a completed stud wall. Exterior wall sheathing 16 typically is covered with a primary moisture barrier 17. In this installation horizontal lap siding 19 is shown as the exterior wall finish, but other siding types are possible. During installation, a hole is cut in the sheathing 16 for the box portion of the exterior semi-recessed electrical junction box. The perimeter flange 2 of the exterior semi-recessed electrical junction box is shown installed and fastened on top of wall moisture barrier 17, but other possible configurations depend on exact construction materials and sequencing. In this installation, additional building paper 18 is lapped over the perimeter flange 2 and tucked under wall moisture barrier 17 above at a horizontal joint in this wall moisture barrier. Any moisture that accumulates on the surface of wall moisture barrier 17 is prevented from gaining entry into the wall cavity 15 by the continuous perimeter flange 2 and protection of additional building paper 18.

In FIG. 8, exterior wall finish 19 horizontal lap siding is installed over wall moisture barrier 17 and trimmed close to but leaving a gap from collar 3. This gap is then closed with sealant over foam backer rod 21, keeping clear of weep holes 11. One type of electrical device 12 is fastened at electrical device mounting surface lugs 5 with machine screws. A commonly available weatherproof exterior electrical junction box cover 14 is shown attached to the electrical device, compressing cover gasket 13. The continuous raised bead on cover mating flange 4 increases compression of cover gasket 13 at the perimeter. Any moisture that bypasses the protective cover 14 and cover gasket 13 and gains entry to the exterior semi-recessed electrical junction box will accumulate at the bottom of collar 3 and drain onto the perimeter flange 2 and wall moisture barrier 17 through weep holes 11.

FIG. 9 is another section of an exterior semi-recessed electrical junction box with electrical device 12; cover gasket 13; and weatherproof cover 14 installed in a stud framed 15 wall. Flexible ROMEX electrical wiring 22 is shown entering the exterior semi-recessed electrical junction box and connecting to electrical device 12. Exterior wall sheathing 16 typically is covered with a primary moisture barrier 17. In this installation exterior wall finish 19 is shown as cement plaster or stucco, but many other siding types are possible. During installation, a hole is cut in the sheathing 16 for the box portion of the exterior semi-recessed electrical junction box. The perimeter flange 2 of the junction box is shown installed and fastened on top of wall moisture barrier 17, but configurations can vary depending on exact construction materials and sequencing. In this installation, additional building paper 18 is lapped over the perimeter flange 2 and tucked under wall moisture barrier 17 above at a horizontal joint in this wall moisture barrier. Any moisture that accumulates on the surface of wall moisture barrier 17 is prevented from gaining entry into the wall cavity 15 by the continuous perimeter flange 2 and protection of additional building paper 18.

In FIG. 9, Stucco 19 requires the use of paper-backed lath 23, which is installed over wall moisture barrier 17 and additional building paper 18 after the exterior semi-recessed electrical junction box is fastened in place. When exterior wall finish 19 cement plaster is applied, cover mating flange 4 provides a reference plane for the finished thickness. Cement plaster exterior wall finish 19 is placed against collar 3, keeping clear of weep holes 11. One type of electrical device 12 is fastened at electrical device mounting surface lugs 5 with machine screws. A commonly available weatherproof exterior electrical junction box cover 14 is shown attached to the electrical device, compressing cover gasket 13. The continuous raised bead on cover mating flange 4 increases compression of cover gasket 13 at the perimeter. Any moisture that bypasses the protective cover 14 and cover gasket 13 and gains entry- to the junction box will accumulate at the bottom of collar 3 and drain onto the perimeter flange 2 and wall moisture barrier 17 through weep holes 11.

Useful embodiments of the invention have been described and illustrated, including depictions of building components necessary to integrate the invention with various surrounding building materials. It is understood that the words used are descriptions rather than limitations, and the present invention is not limited to the embodiments described above, but encompass any and all embodiments within the scope of the following claims.

The invention claimed is:

1. An exterior semi-recessed electrical junction box article used in building construction, said article comprised of:
a. an electrical junction box having sides, top and bottom, back, and open front.
b. an electrical junction box with a back side having one or more openings and corresponding opening flaps and wire diverters for electrical conductors and wires.
c. an electrical junction box having a two or more mounting surface lug and screw holes for fastening common electrical devices within.

2. An exterior semi-recessed electrical junction box article as recited in claim 1, wherein said article has a continuous perimeter flange projecting out from and at right angles to box sides, top and bottom, and contains mounting holes for fastening the electrical junction box to wall sheathing or framing.

3. An exterior semi-recessed electrical junction box article as recited in claim 2, wherein said article has a collar that projects from and is at right angles to the perimeter flange of claim 2. This collar surrounds electric device mounting lugs, and has weep holes in the bottom plane.

4. An exterior semi-recessed electrical junction box article as recited in claim 3, wherein said article has a flat cover mating flange projecting from and at right angles to the collar in claim 3. This flange has a raised bead at its outward edge.

5. An exterior semi-recessed electrical junction box article as recited in claim 1, said article being formed of plastic material with rounded edges.

6. An exterior semi-recessed electrical junction box article as recited in claim 1, said article round in shape.
